(19) United States
(12) Patent Application Publication
(10) Pub. No.: US 2010/0114373 A1
(43) Pub. Date: May 6, 2010

(54) SYSTEMS AND METHODS FOR SCANNING A WORKSPACE VOLUME FOR OBJECTS

(75) Inventors: Shane Hale, Sharpsburg, GA (US); Scott Coleman, Atlanta, GA (US); Parks Stewart, Norcross, GA (US)

Correspondence Address: DUANE MORRIS LLP - Atlanta;IP DEPARTMENT, ATLANTIC CENTER PLAZA, 1180 WEST PEACHTREE STREET, NW SUITE 700, ATLANTA, GA, 30309-3348, US

(73) Assignee: CAMOTION, INC., Atlanta, GA (US)

(21) Appl. No.: 12/611,102

(22) Filed: Nov. 2, 2009

Related U.S. Application Data
(60) Provisional application No. 61/110,374, filed on Oct. 31, 2008.

(51) Int. Cl. B25J 19/06; G06F 19/00; G05B 15/00; B25J 19/02; B25J 9/00

(52) U.S. Cl. 700/258; 700/245; 901/46; 901/49

(57) ABSTRACT

A representative robotic machine includes an end-of-arm that is located in a work area; and a safety scanner system that scans for objects in a workspace volume around the end-of-arm. The safety scanner system determines whether to stop operations of the robotic machine based on the presence of the objects in the workspace volume.

### CROSS-REFERENCE TO RELATED APPLICATIONS

This application claims the benefit of U.S. provisional patent application Ser. No. 61/110,374 filed Oct. 31, 2008, the entirety of which application is expressly incorporated by reference herein.

### TECHNICAL FIELD

The present disclosure is generally related to robotic machines and, more particularly, is related to robotic machines that handle heavy payloads over long distances.

### BACKGROUND

It has become more and more common to consider work areas that are shared by people and robots. As such, accidents between the robots and people may also increase. The robotic machines are typically designed to have provisions for separate but changing volumes for the robotic arm and operators. The direction is toward smaller volumes for the robotic machines relative to the operators. The industry has moved from rather large stationary volumes that are entered by the people with the robotic machine off to moving volumes surrounding the moving parts of the robotic machine with people still within the possible range of the motion of the robotic machine. This allows people to enter a volume that has previously been used by the robotic machine and vice versa.

Generally after any stop, an operator verifies that a work area is free of any person and then pushes a resume “button” or device to resume operation of the robotic machine. This approach has the shortcoming of depending on manual verification, itself not as reliable it might seem, and furthermore causing a delay.

Desirable in the art is an improved robotic machine that reduces physical injuries, particularly serious injuries, as a result of accidents caused by the contact of a person with the robotic machine.

### SUMMARY

A representative robotic machine includes an end-of-arm; and a safety scanner system that scans for objects in a workspace volume around the end-of-arm. The safety scanner system determines whether to stop operations of the robotic machine based on the presence of the objects in the workspace volume.

Other systems, devices, methods, features of the invention will be or will become apparent to one skilled in the art upon examination of the following figures and detailed description. It is intended that all such systems, devices, methods, features be included within the scope of the invention, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a perspective view of an exemplary robotic machine that includes an overhead rail mounted machine in accordance with an embodiment of the present disclosure.

FIG. 2 is a top view that illustrates a work area having a scanned area generated from a robotic machine in accordance with an embodiment of the present disclosure.

FIG. 3 illustrates a safety scanner system implemented on an overhead rail mounted machine in accordance with an embodiment of the present disclosure.

FIG. 4 is a flow diagram that illustrates an embodiment of the architecture, functionality, and/or operation of a safety scanner system in accordance with an implementation of the present disclosure.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which a work area is scanned for objects.

This disclosure addresses the issue of scanning a workspace volume, e.g., the area around the end-of-arm of the robotic machine, to assure that no person is present in a work area. Before scanning, a first provides an obstacle free conventional boundary of the work area, typically optical in nature. In either case, a boundary around the robotic machine is provided into which persons or other unexpected items should not intrude.

This disclosure is related to mechanisms that make robotic machines more safe with an emphasis on reducing any damage to persons and equipment because of the robotic motion. The damage reduction is achieved by detection of persons or things near a payload. A mechanism, among others, for achieving this is to detect that people are not near an end-of-arm (BOA) of the robotic machines even when people may be within the possible workspace of the BOA.

The robotic machines described in this disclosure generally handle heavy payloads over long distances. However all of the described mechanism can be applied to many robotic situations and many machines used in moving material automatically or with mechanical assistance. The robotic machines utilize technologies related to position estimation, learned control effort, and command shaping that can allow the construction of lightweight, imprecise machines to achieve high-speed, accurate motion. Such technologies have been disclosed in U.S. Pat. Nos. 5,946,449, to Dickerson, et al. and 6,078,844, to Magee, et al., the entirety of which applications are expressly incorporated by reference herein.

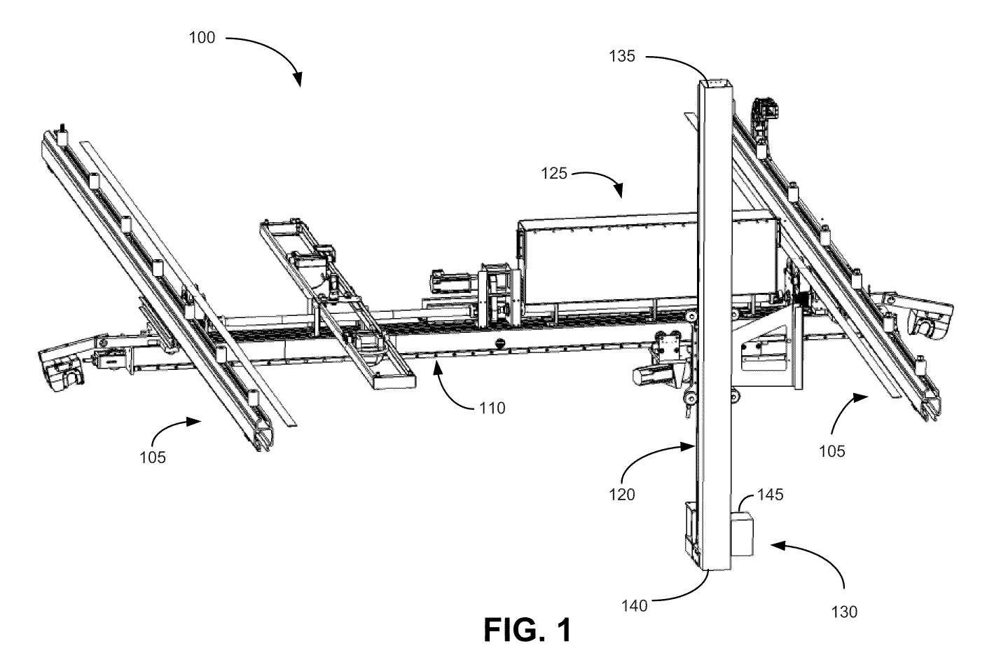

The fabrication of the robotic machine can take a wide variety of forms. FIG. 1 is a perspective view of an exemplary robotic machine 100 that includes an overhead rail mounted machine in accordance with an embodiment of the present disclosure, In this example, an end-of-arm (BOA) 130 of the robotic machine 100 generally extends from the ceiling to the ground and can cause injury to people. The robotic machine 100 can be designed to move payloads held at the end-of-a n (BOA) 130 from place to place in a fast, reliable, accurate, and safe manner.

X rails 105 are placed parallel to each other and are generally attached to a top structure (not shown), such as, a ceiling beam. A Y bridge 110 is coupled to the bottom of the X rails 105, generally at the ends of the Y bridge 110. The Y bridge 110 is positioned substantially perpendicular to the X rails 105. A control module 125 is placed on top of the Y bridge 110. The control module 125 includes a computing device, motors, and sensors, among others, that can facilitate moving the Y bridge 110 along the X rails 105 in the X direction. The Y bridge 110 is coupled to a Z beam 120, which roves along the Y bridge 110 in the Y direction.

The Z beam 120 can move up and down in the Z direction. The Z beam 120 includes a proximal and 135 and distal and 140 in which the distal end 140 is coupled to a mounting plate 145. The mounting plate 145 can include, but is not limited to, tooling devices and gripping devices. The distal end 140 of the Z beam 120 is generally referred to the end-of-arm (EOA) 130.

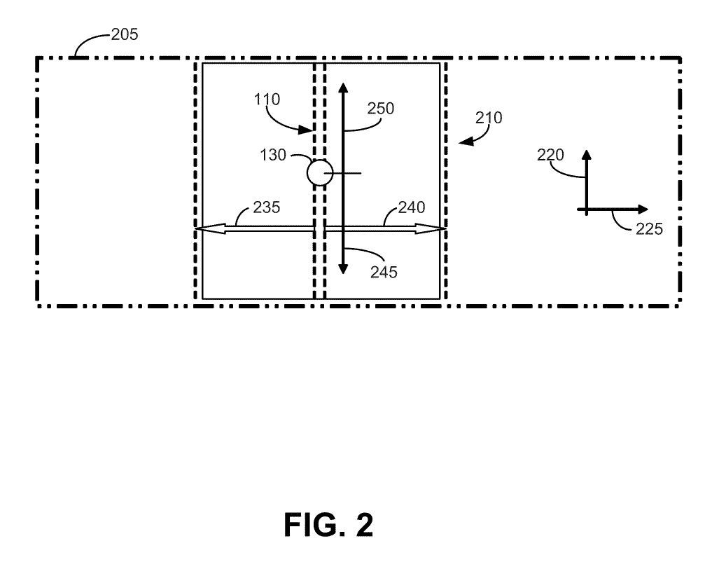

FIG. 2 illustrates a work area 205 that includes a scanned area 210 generated from a robotic machine 100 in accordance with an embodiment of the present disclosure. The Z beam 120 includes the BOA 130 that can move along the Y bridge 110 in the Y direction 220. A scanned workspace volume around the robotic machine 100 includes a mechanism that detects people entering the scanned area 210. The scanned area 210 may move with the robotic machine 100 or robot EOA 130. A person penetrating the scanned area 210 can cause a controlled stop, halting operations of the robotic machine 100.

Current technology for example scanners by SICK inc. and others are capable of safety rated scans every 60 ins at distances up to 7 meters. The later measurement type is assumed here to be used at 0.25 degree steps in distance and take 53 ms total scan time for 180 degree scans. The scanned workspace volume moves around the work area 205 as scanners move with the EOA 130. For example, the initial scanned workspace volume may be positioned in a location of the work area 205 that a person may not be within. As the EOA 130 moves to another location of the work area 205, the scanned workspace volume also moves with the EOA 130 and may now be in the area that a person is operating the robotic machine 100.

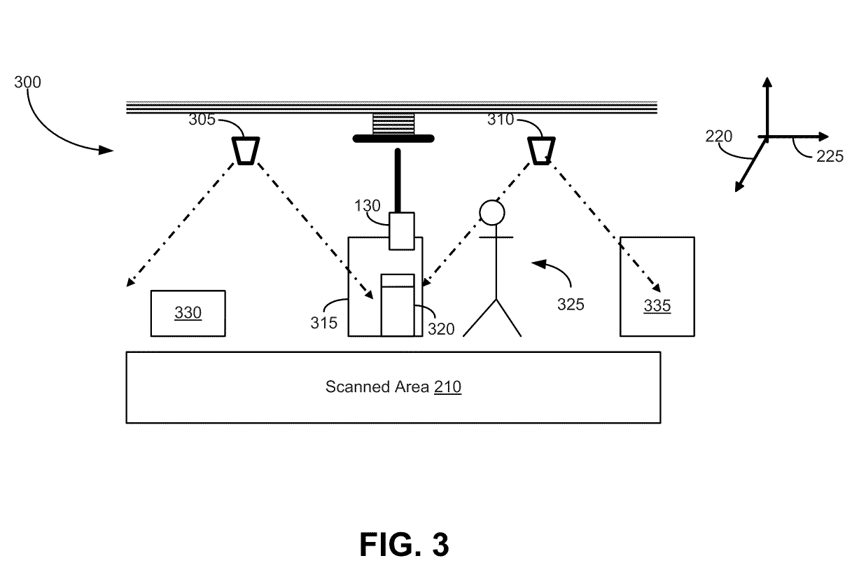

Scanners 305, 310 (FIG. 3) can be used to scan from the Y bridge 110 out towards the boundaries of the scanned area 210 to vent S' a person is not present before lowering the robot gripper or EOA 130 into a robotic work space (not shown). The scanners 305, 310 scans a broad width in the Y direction 220 and each moves from the Y bridge 110 to the outside of the scanned area 210, that is in −/+f-X direction 235, 240 to check of the area is clear of people. This permits scanning of a large volume over a period generally of one or more seconds. More scanners 305, 310 can be utilized to scan in the −/+Y directions 245, 250 in order to establish a complete rectangle of the scanned area 210.

Note that once the scanners 305, 310 are in the out position and no person has been found the robotic machine can start operations and the scanners remain in the out position. Note also that the concept can be generalized to have moveable scanners in both the X and Y directions 225, 220 so that the rectangular box of protection can be moveable in two directions.

FIG. 3 illustrates a safety scanner system 300 implemented on an overhead rail mounted machine 100 in accordance with an embodiment of the present disclosure. The safety scanner system 300 includes scanners 305, 310 that can be coupled to the control module 125 (FIG. 1), which includes a scanner software (not shown) having instructions for controlling the scanners 305, 310. The scanners 305, 310 scan a range in the X direction 225 and the moves from the middle to the outside (bottom) in the X direction 225. Note that this permits scanning of a large volume over a period generally of one or more seconds. Alternatively or additionally, the scanners 305, 310 can have vertical patterns and move mechanically outward in the X direction 220 when scanning rather than having rotating planes of beams. The safety scanner system 300 can scan for the objects in the workspace volume by moving planes of laser beams with, for example, a servo or other motion device. The safety scanner system 300 can determine the workspace volume above the work area 205 by using, for example, three or more planes of the laser beams

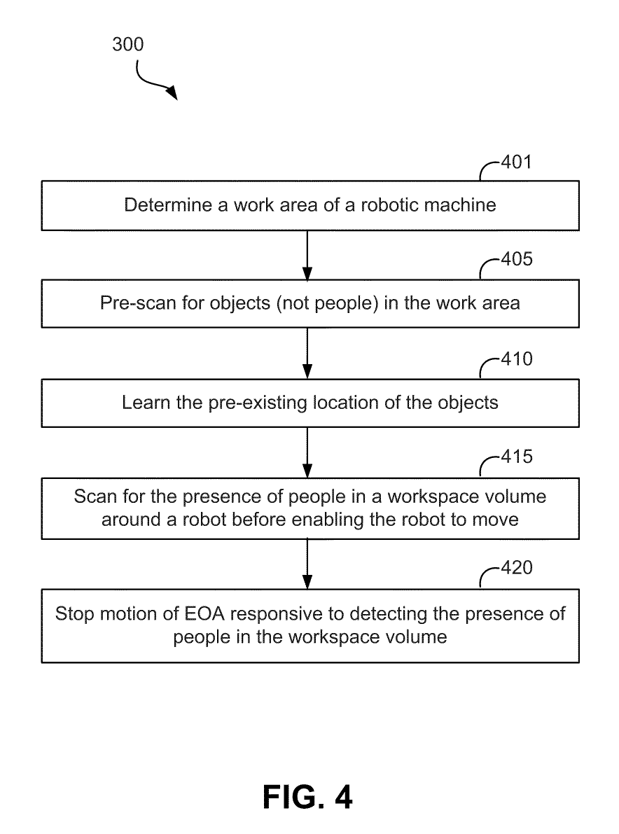

FIG. 4 is a flow diagram that illustrates an embodiment of the architecture, functionality, and/or operation of a safety scanner system 300 in accordance with an implementation of the present disclosure. In block 401, the safety scanner system 300 determines a work area 205 of the robotic machine 100. In block 405, the safety scanner system 300 scans the work area 205 in advance of the positions of objects 315, 320, 330, 335 (FIG. 3) in the work area 205 so that the workspace volume effectively is safe for people 325 (or other objects not expected in the work area 205). For example, the safety scanner system 300 scans the workspace volume around the EOA 130 at multiple locations in the work area 205 until the entire work area 205 is scanned for, e.g., stationary or expected objects. The stationary or expected objects 315, 320, 330, 335 in the work area 205 should not be detected as people. The objects 315, 320, 330, 335 include, but are not limited to, boxes, pallets, plants, desk, chairs, tool boxes, and a desktop, among others. To overcome the difficulty of determining whether people are in the work area 205, a pre-scan can be made when no person is present and no unexpected objects are present.

In block 410, the safety scanner system 300 learns the pre-existing location and profiles in the X, V, and Z directions of the objects 315, 320, 330, 335. In block 415, the safety scanner system 300 scans for the presence of people in a volume around the, e.g., EOA 125, before enabling the robotic machine to operate. In block 420, the safety scanner system 300 can halt operation of the robotic machine 100 responsive to detecting a person in the workspace volumen. The scanning for the presence of people can be accomplished by way of imaging based on range, which can be described as range imaging. The current state of the art suggests that cameras will soon be able to do a very similar function.

The scanning process determines the locations of objects 315, 320, 330, 335 and scan for people such that the scanner system 300 is not fooled by the objects 315, 320, 330, 335. This learned pattern would be created relatively infrequently. The ability of robots to know the locations of the objects 315, 320, 330, 335, as described in connection with blocks 405 and 410, would be used to allow the scanning for people to be done properly

Range imaging was previously described to detect people in the work area 205. Range imaging can utilize a vision-based system that uses multiple cameras to detect anything visible within a set of programmable volumes on the basis of triangulation. A sensor head of the vision-based system can move to facilitate detecting objects in the work area 205.

Other sensors can be used to reliably find people or other objects within the work area 205. The sensors can distinguish people from objects 315, 320, 330, 335. Some alternatives are described are follows:
Infrared cameras are a way of detecting people as “hot spots”. However, it is not clear how well these would do, particularly in the summer if the temperature of natural objects goes near 90 degrees.
Acoustic range sensors are relatively cheap and light and could be in an array in the secondary enclosure. Unfortunately people are not very good targets for such sensors as the acoustic reflection is unreliable. Further beam spreads tend to be large.

Radio beacons can be used to track all objects, such as people, if the radio beacons are attached to the objects. The objection to this is reliability as it requires that people wear the devices and maintain a good position relative to RF reflective surfaces, typically metals or other conductors.

The systems and methods disclosed herein can be implemented in software, hardware, or a combination thereof. In some embodiments, the system and/or method is implemented in software that is stored in a memory and that is executed by a suitable microprocessor (μP) situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example, but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) optical fiber and compact disc read-only memory (CD-ROM).

Note that the computer-readable medium could even be paper or another suitable medium on which the program is printed. Using such a medium, the program can be electronically captured (using, for instance, optical scanning of the paper or other medium), compiled, interpreted or otherwise processed in a suitable manner, and then stored in a computer memory. In addition, the scope of the certain embodiments of the present disclosure includes embodying the functionality of the preferred embodiments of the present disclosure in logic embodied in hardware or software-configured mediums.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

1. A robotic machine comprising:
an end-of-arm; and
a safety scanner system that scans for objects in a workspace volume around the end-of-arm, wherein the safety scanner system determines whether to stop operations of the robotic machine based on the presence of the objects in the workspace volume.

2. The robotic machine as defined in claim 1, wherein the safety scanner system scans multiple workspace volumes such that an entire work area of the robotic machine is scanned for the objects.

3. The robotic machine as defined in claim 1, wherein the workspace volume is pre-scanned for the objects that are determined to be excluded from the workspace volume.

4. The robotic machine as defined in claim 1, wherein the safety scanner system scans for the objects in the workspace volume by moving planes of laser beans with a servo or other motion device.

5. The robotic machine as defined in claim 4, wherein the safety scanner system determines the workspace volume above the work area by using three or more planes of the laser beams.

6. The robotic machine as defined in claim 4, wherein if the workspace volume is penetrated by the objects, the safety scanner system scans the workspace volume repeatedly until the objects are determined to be no longer present.

7. The robotic machine as defined in claim 6, wherein the safety scanner system scans the workspace volume by moving the planes of the laser beams in a predetermined motion until objects are determined to be no longer present.

8. The robotic machine as defined in claim 1, wherein the objects include at least one of the following: boxes, pallets, plants, desk, chairs, tool boxes, and a desktop.

9. A safety scanner system comprising:
at least one scanner that scans for objects in a workspace volume around an end-of-aim of a robotic machine;
a processing device; and
memory including a scanning software which has instructions that are executed by the processing device, the instructions including the following:
instructing the at least one scanner to scan the workspace volume,
determining whether the objects are detected in the workspace volume, and
responsive to detecting the objects in the workspace volume, determining whether to stop operations of the robotic machine based on the presence of the objects in the workspace volume.

10. The safety scanner system as defined in claim 9, wherein the scanning software instructs the scanner to scan multiple workspace volumes such that an entire work area of the robotic machine is scanned for the objects.

11. The safety scanner system as defined in claim 9, wherein the scanning software instructs the at least one scanner to scan the workspace volume for the objects that are determined to be excluded from the workspace volume.

12. The safety scanner system as defined in claim 9, wherein the at least one scanner is a laser beam and the safety scanner system scans for the objects in the workspace volume by moving planes of the laser beam with a servo or other motion device.

13. The safety scanner system as defined in claim 12, where the scanning software determines the workspace volume above the work area by three or more planes of the of laser beams.

14. The safety scanner system as defined in claim 12, wherein if the workspace volume is penetrated by the objects, the scanning software instructs the laser beam to scan the workspace volume repeatedly until the objects are determined to be no longer present.

15. The safety scanner system as defined in claim 14, wherein the scanning software instructs the laser beam to scan the workspace volume by moving the planes of the laser beams in a pre-determined motion until objects are determined to be no longer present.

16. The safety scanner system as defined in claim 9, wherein the objects include at least one of the following: boxes, pallets, plants, desk, chairs, tool boxes, and a desktop.

17. A safety scanner system comprising:
at least one scanner that scans for Objects in a workspace volume around an end-of-aim of a robotic machine;
a processing device; and
memory including a scanning software which has instructions that are executed by the processing device, the instructions including the following:
instructing the at least one scanner to scan multiple workspace volumes such that an entire work area of the robotic machine is scanned for the objects,
instructing the at least one scanner to scan the workspace volume at an operating area of the robotic machine,
determining whether the objects are detected in the workspace volume, and
responsive to detecting the objects in the workspace volume,
determining whether to stop operations of the robotic machine based on the presence of the objects in the workspace volume.

18. The safety scanner system as defined in claim 17, wherein the scanning software instructs the at least one scanner to scan the workspace volume for the objects that are determined to be excluded from the workspace volume.

19. The safety scanner system as defined in claim 17, wherein the at least one scanner is a laser beam and the safety scan scans for the objects in the workspace volume by moving planes of the laser beam with a servo or other motion device.

20. The safety scanner system as defined in claim 19, where the scanning software determines the workspace volume above the work area by using three or more planes of the of laser beams.
